(19) United States
(12) Patent Application Publication
(10) Pub. No.: US 2010/0046069 A1
(43) Pub. Date: Feb. 25, 2010

(54) METHOD AND ARRANGEMENT FOR THREE-DIMENSIONAL REPRESENTATION

(76) Inventors: Stephan Otte, Jena (DE); Markus Klippstein, Jena (DE)

Correspondence Address: Muncy, Geissler, Olds & Lowe, PLLC, P.O. BOX 1364, FAIRFAX, VA, 22038-1364, US

(21) Appl. No.: 12/573,664

(22) Filed: Oct. 5, 2009

Related U.S. Application Data
(63) Continuation of application No. PCT/DE2007/002136, filed on Nov. 26, 2007.

(30) Foreign Application Priority Data
Apr. 4, 2007 (DE) DE102007016773.5

(51) Int. Cl. G02B 27/22

(52) U.S. Cl. 359/462

(57) ABSTRACT

The invention relates to the field of spatial representation, particularly to images which are spatially perceivable for simultaneous multiple viewers without auxiliary devices so-called autostereoscopic visualization. The invention addresses the problem of creating a form of autostereoscopic representation based on barrier technology in order to achieve an improved perceptibility for multiple simultaneous viewers. This problem is solved by a method for spatial representation wherein image section data of different viewpoints A(k), where k=1, . . . , n and n=6 or n=7, are made visible on a grid of image elements x(i,j), and at least one parallax barrier screen containing alternating opaque and transparent sections is placed at a distance before or behind the grid of image elements x(i,j). The transparent sections substantially correspond to straight bordered lines which, during the parallel projection of parallax barrier screens onto the grid of image elements x(i,j), are inclined to at least 21 degrees with respect to the vertical direction of the grid of image elements x(i,j) and, furthermore, each have the width of at least 1.9 image elements x(i,j) in the horizontal direction of the grid of image elements x(i,j).

This nonprovisional application is a continuation of International Application No. PCT/DE2007/002136, which was filed on Nov. 26, 2007, and which claims priority to German Patent Application No. DE 10 2007 016 773.5, which was filed in Germany on Apr. 4, 2007, and which are both herein incorporated by reference.

### BACKGROUND OF THE INVENTION

1. Field of the Invention

The invention relates to the field of spatial representation, specifically to the representation spatially perceptible without aids for simultaneous multiple viewers, the so-called autostereoscopic visualization.

2. Description of the Background Art

There have been approaches for some time to the aforementioned field. A pioneer in this field was Frederic Ives, who in the publication GB190418672 A proposed a system with a “line screen” for 3-D imaging. Further, fundamental findings on the use of barrier screens for 3-D imaging are described in the publication by Sam H. Kaplan “Theory of parallax barriers,” Journal of SMPTE, Vol. 59, No. 7, pp. 11-21, July 1952.

A widespread dissemination of autostereoscopic systems did not occur for a long time, however. A certain renaissance of 3-D systems began only in the eighties of the 20^{th} century, because of the now available computing power and novel display technologies. In the 1990s, the number of patent applications and publications for glasses-free 3-D visualizations positively shot up. Outstanding results were achieved by the following inventors or suppliers:

In JP 8-331605 AA, Dr. Goro Hamagishi (Sanyo) describes a step barrier in which a transparent barrier element has approximately the dimensions of a color subpixel (R, G, or B). With this technology, it was possible for the first time to transfer the resolution loss, occurring in most autostereoscopic system, based on the representation of simultaneous multiple viewpoints (at least two, preferably more than two viewpoints) in the horizontal direction in part also to the vertical direction. A disadvantage here, as in all barrier methods, is the high light loss. In addition, the stereo contrast with sideways movement of the viewer changes from almost 100% to about 50% and then again increases to 100%, which has a result of a fluctuating 3-D image quality within the viewing space.

Pierre Allio with the teaching according to U.S. Pat. No. 5,808,599 A, U.S. Pat. No. 5,936,607 A, and International Pat. Appl. No. WO 00/10332 A1 achieved a notable refinement of lenticular technology, while also utilizing a subpixel-based separation of viewpoints.

An application for a patent for another outstanding finding was submitted by C. van Berkel with European Pat. Appl. No. EP 791 847 A1, which corresponds to U.S. Pat. No. 6,064,424. In this case, lenticular lenses inclined compared with the vertical overlie a display, which also shows different perspective viewpoints. Characteristically here n views are divided into at least two display lines, so that loss of resolution from the horizontal is again transferred in part to the vertical.

Lenticular lenses, however, can be produced only in a costly manner and the production process for a 3-D display based thereon is not trivial.

Jesse Eichenlaub achieved several milestones for autostereoscopy with the publications U.S. Pat. No. 6,157,424 A and International Pat. Appl. No. WO 02/35277 A1 and several other inventions, almost all of which however represent 3-D systems for only one viewer and/or often cannot be produced at an acceptable cost.

In German Pat. Appl. No, DE 10 003 326 C2, Armin Grasnick et al. achieved a refinement of the barrier technology in regard to two-dimensional structured wavelength-selective filter arrays to produce a 3-D impression. A disadvantage here as well, however, is the greatly reduced brightness of this type of 3-D systems in comparison with a 2-D display.

Armin Schwerdtner with the International Pat. Appl. No. WO 2005/027534 A2 achieved a novel technological approach for a 3-D image fully resolved in all (usually two) views. Nevertheless, this approach involves a high adjustment effort and is only extremely difficult to implement for larger screen diagonals (from about 25 inches).

Finally, Wolfgang Tzschoppe et al. filed the International Pat. Appl. No. WO 2004/077839 A1, which relates to a barrier technology improved in regard to brightness. Based on the approach of a step barrier disclosed in JP 08-331605 AA and DE 10 003 326 C2, a special line-to-space ratio of the transparent to the opaque barrier filter elements is presented here, which is greater than 1/n with n being the number of the displayed viewpoints. The embodiments and teaching disclosed in this publication, however, usually produce unpleasant moiré effects and/or a greatly limited depth perception, because the stereo contrast is greatly reduced, compared with, for instance, the teaching of JP 08-331605 AA.

In the present publication, “visible (monocular) resolution in a 3-D display” is understood to be the resolution which is seen in full color per viewer's eye in a time and spatial average upon viewing a 3-D display.

### SUMMARY OF THE INVENTION

It is therefore an object of the present invention to provide a possibility for autostereoscopic representation based on barrier technology to achieve improved perceptibility for multiple simultaneous viewers.

This object is achieved by means of a method for spatial representation, in which image section data of different viewpoints A(k) with k=1, . . . , n and n=6 or n=7 are made visible on a grid of image elements x(i,j), and at least one parallax barrier screen, which contains alternately opaque and transparent sections, is placed before or behind the grid of image elements x(i,j) at the distance s, whereby the transparent sections correspond substantially to straight bordered lines, which in parallel projection of the parallax barrier screen onto the grid of the image elements x(i,j) are inclined by at least 21 degrees with respect to the vertical direction of the grid of image elements x(i,j) and further in the horizontal direction of the grid of the image elements x(i,j) in each case have at least the width of 1.9 image elements x(i,j), so that one or more viewers based on the view limitation effect by the at least one parallax barrier screen substantially see different image elements x(i,j) and/or parts thereof in each case with both eyes, as a result of which both eyes in each case perceive substantially different viewpoints A(k) and a spatial visual impression thereby results.

For all subsequent embodiments, precisely one parallax barrier screen is assumed, although for certain applications multiple parallax barrier screens of this type can be advantageous.

The index i addresses the rows and the index j the columns on the grid of image elements x(i,j).

The number of 6 or 7 viewpoints, on the one hand, permits efficient 3-D content generation and, on the other, produces a good 3-D impression.

With the embodiment of the invention of an inclination angle of the transparent sections of the parallax barrier screen of at least 21 degrees, the unpleasant moiré effects are largely prevented. In addition, the width of the invention of the transparent sections formed with straight bordered lines provides very good brightness and simultaneously very good (monocular) resolution of the perceived 3-D image.

The parameters for the parallax barrier screen can be calculated simply with the help of the two equations (1) and (2) known from the aforementioned Kaplan article. All necessary relations are obtained between the distance s between the grid of image elements x(i,j) and the parallax barrier screen, the average eye distance in humans set to 65 mm, the viewing distance, the (horizontal) period length of the transparent sections of the barrier, and the strip width of said transparent sections.

In the method of the invention, the arrangement of the image section data of the different viewpoints A(k) on the grid of image elements x(i,j) occurs advantageously in a two-dimensional periodic pattern, whereby the period length in the horizontal and vertical direction preferably does not comprise more than 32 image elements x(i,j) in each case. Exceptions to this upper limit of 32 image elements x(i,j) in each case are allowable.

The vertical period length can be equal to the number n of the represented viewpoints. Furthermore, the image elements x(i,j) in each case correspond to individual color subpixels (R, G, or B) or clusters of color subpixels (e.g., RG, GB, or RGBR or others) or full color pixels, whereby full color pixels are taken to mean both white-blending structures of RGB color subpixels, therefore RGB triplets, and actual full color pixels depending on the imaging technology, as is common, for instance, in projection screens.

The angle, which spans said horizontal and vertical period length of said two-dimensional periodic pattern as opposite and adjacent sides, should normally correspond substantially to the inclination angle of the transparent sections on the parallax barrier screen with respect to the vertical. The best channel separation in the 3-D representation is achieved in this way.

Furthermore, said horizontal and vertical period length of said two-dimensional periodic pattern should coincide with the respective horizontal and vertical period lengths of the transparent sections of the parallax barrier screen, except in the case of a correction factor y, whereby 0.98<y<1.02.

As in various other 3-D reproduction methods, the viewpoints A(k) each correspond to different perspectives of a scene or an object.

The object of the invention is achieved further by an arrangement, realizing the method of the invention, for spatial representation, comprising an image display device with image elements x(i,j) in a grid (i,j), on which image section data of different viewpoints A(k) with k=1, . . . , n and n=6 or n=7 can be made visible, at least one parallax barrier screen, which is placed before or behind the image display device with image elements x(i,j) at the distance s and which contains alternately opaque and transparent sections, whereby the transparent sections correspond substantially to straight bordered lines, which in parallel projection of the parallax barrier screen onto the grid (i,j) with the image elements x(i,j) are inclined by at least 21 degrees with respect to the vertical direction of the grid (i,j) of image elements x(i,j) and further in the horizontal direction of the grid with the image elements x(i,j) in each case have at least the width of 1.9 image elements x(i,j), so that one or more viewers based on view limitations by the at least one parallax barrier screen substantially see different image elements x(i,j) and/or parts thereof in each case with both eyes, as a result of which both eyes in each case perceive substantially different viewpoints A(k) and a spatial visual impression thereby results.

In this case as well, at first only one parallax barrier screen is assumed in the following description.

The assignment of the image section data of the different viewpoints A(k) to the image elements x(i,j) occurs in a two-dimensional periodic pattern, whereby the period length in the horizontal and vertical direction preferably does not comprise more than 32 image elements x(i,j) in each case.

The vertical period length can be equal to the number n of the represented viewpoints.

Furthermore, the image elements x(i,j) in each case can correspond to individual color subpixels (R, G, or B) or clusters of color subpixels (e.g., RG, GB, or RGBR, or others) or full color pixels, whereby full color pixels are taken to mean both white-blending structures of RGB color subpixels, therefore RGB triplets, and actual full color pixels depending on the imaging technology, as is common, for instance, in projection screens.

The angle, which spans said horizontal and vertical period length of said two-dimensional periodic pattern as opposite and adjacent sides, corresponds substantially to the inclination angle of the transparent sections on the parallax barrier screen with respect to the vertical.

Furthermore, the horizontal and vertical period length of the two-dimensional periodic pattern should coincide with the respective horizontal and vertical period lengths of the transparent sections of the parallax barrier screen, except in the case of a correction factor y, whereby 0.98<y<1.02.

The image display device can be preferably a color LCD screen, a plasma display, a projection screen, an LED-based display, an SED display, or a VFD display.

Preferably, 6 viewpoints with a horizontal period lengths of 8 image elements x(i,j) can be provided.

To achieve practically easily producible arrangements, the parallax barrier screen preferably consists of a glass substrate, to the back of which the barrier structure is applied. Other embodiments are possible, such as, for instance, substrates that do not consist of glass (e.g., of plastic).

The barrier structure can be an exposed and developed photographic film, which is laminated to the back of the glass substrate, whereby preferably the emulsion layer of the photographic film does not face the glass substrate. In contrast, it is also possible that the opaque areas of the barrier structure are formed by color printed on the glass substrate.

Further, the parallax barrier screen advantageously contains means to reduce spurious light reflections, preferably at least one interference optical antireflection coating. Typical antiglare matting may also be used.

The parallax barrier screen is applied permanently by means of a spacer element to the image display device, for example, glued or screwed on.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the schematic structure for realizing the method of the invention;

FIG. 2 shows a parallax barrier screen for use in the method of the invention;

FIG. 3 shows an exemplary image combination of the image section data of different viewpoints;

FIG. 4 shows view examples for a first viewer's eye taking the relations in FIGS. 1 through 3 as a basis;

FIG. 5 shows view examples for a second viewer's eye taking the relations in FIGS. 1 through 3 as a basis; and

FIG. 6 shows a diagram for dimensioning the parallax barrier screen.

### DETAILED DESCRIPTION

The drawings are not to scale. This refers in particular also to the angular dimensions.

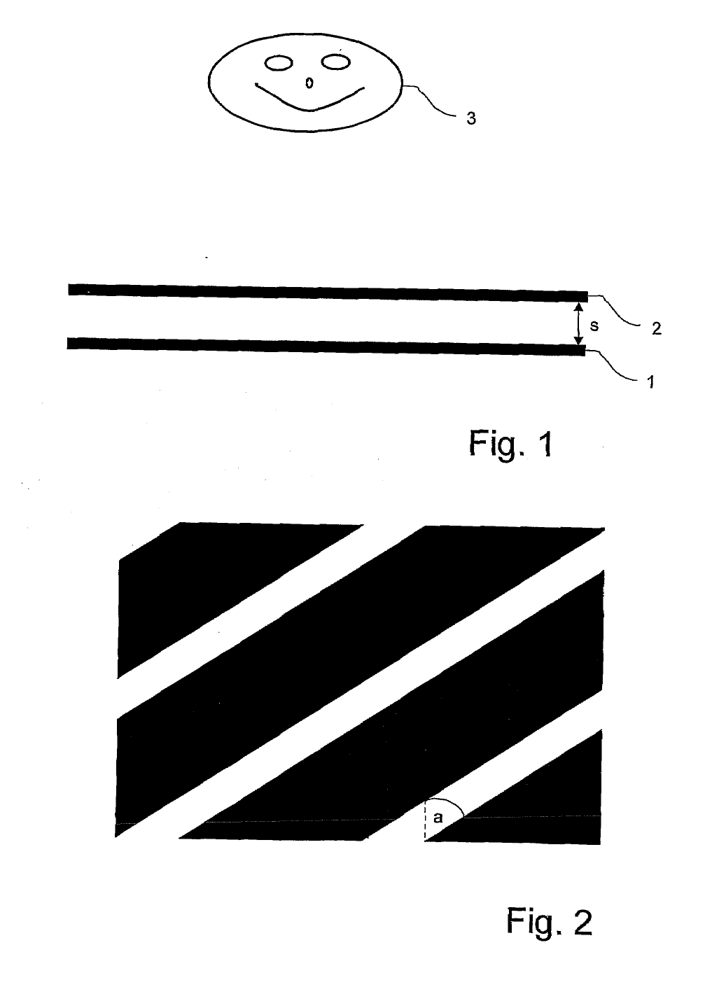

FIG. 1 shows a schematic structure for realizing the method of the invention. This includes a grid 1 of image elements x(i,j), on which image section data of different viewpoints A(k) with k=1, . . . , n and n=6 or n=7 are made visible, and a parallax barrier screen 2 placed before grid 1 of image elements x(i,j) at the distance s in viewing direction of a viewer 3. Of course, there can also be several viewers 3 who-obtain a spatial impression based on the method of the invention.

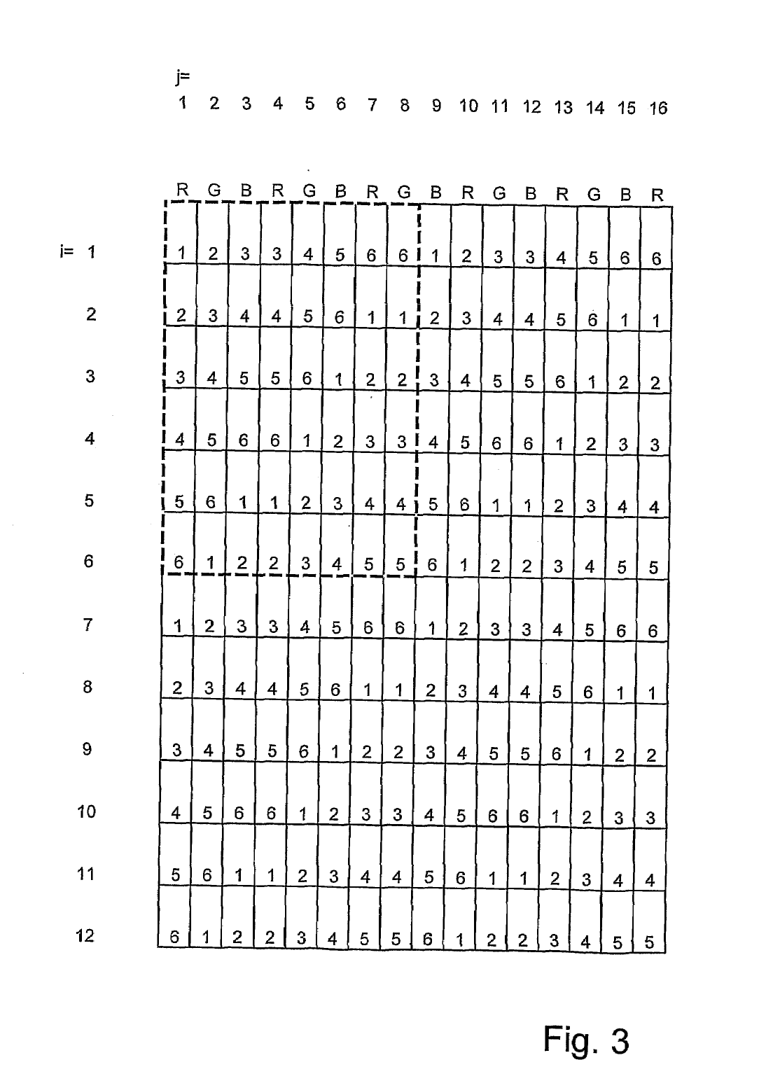

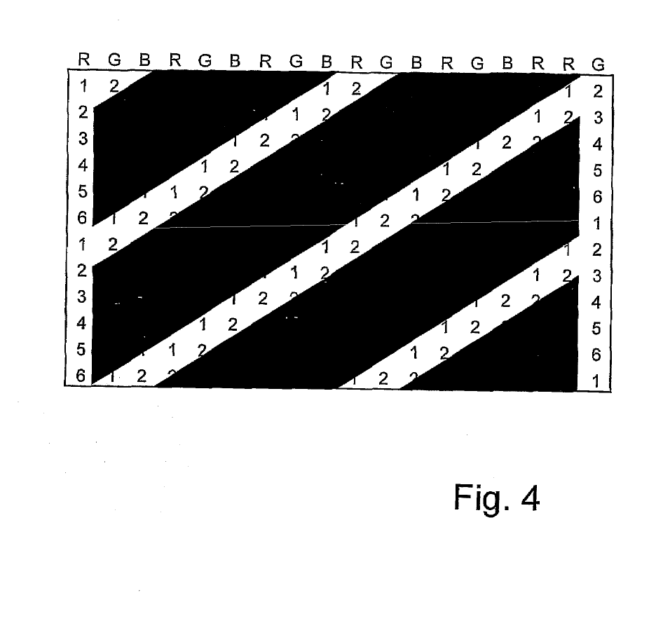

FIG. 2 shows a section of a parallax barrier screen 2 for use in the method of the invention. This parallax barrier screen 2 contains alternately opaque and transparent sections, whereby the transparent sections according to the invention correspond substantially to straight bordered lines, which in parallel projection of parallax barrier screen 2 onto grid 1 of image elements x(i,j) are inclined by at least 21 degrees with respect to the vertical direction of grid 1 of image elements x(i,j) and further in the horizontal direction of grid 1 of image elements x(i,j) in each case have at least the width of 1.9 image elements x(i,j). Said inclination angle of at least 21 degrees is drawn in here as angle a; because the drawing is not to scale, it appears to be even much greater than 21 degrees. Said required width of the transparent sections can be clearly gathered visually from FIG. 3 and FIG. 4.

Of course, as is known to the person skilled in the art, the parameters for parallax barrier screen 2 are calculated according to the two equations (1) and (2) known from the aforementioned Kaplan article; exemplary parameters are given further hereafter. Input parameters in this case are particularly also the height and width of the image elements x(i,j).

FIG. 3 shows an exemplary image combination of the image section data of six different viewpoints A(k) with k=1, . . . , 6. In the method of the invention, the arrangement of the image section data of different viewpoints A(k) on grid 1 of image elements x(i,j) occurs advantageously in a strictly two-dimensional periodic pattern. In the example according to FIG. 3, the horizontal period length comprises 8 image elements and the vertical period length 6 image elements x(i,j), as indicated by the dashed line frame. In this case, the image section data for each image element x(i,j) stem in each case from the position (i,j) from the corresponding viewpoint A(k).

In the design example presented here, the vertical period length therefore corresponds advantageously to the number n=6 of the shown viewpoints.

Further, the image elements x(i,j) in each case correspond to individual color subpixels (R, G, or B).

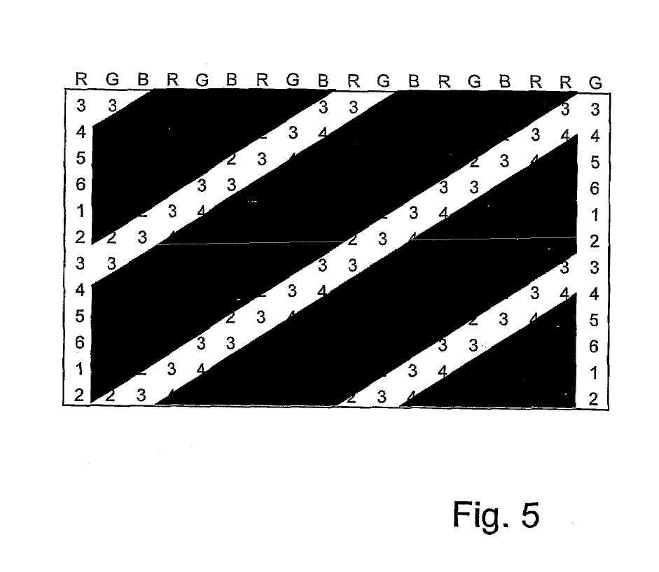

FIG. 4 and FIG. 5 show view examples for a first or a second viewer's eye taking the relations in FIGS. 1 through 3 as a basis. In this case, parallax barrier screen 2 is placed at a distance s in the viewing direction before grid 1 of image elements x(i,j).

Based on the view limitation effect of parallax barrier screen 2, one or more viewers 3 each see with both eyes substantially different image elements x(i,j) and/or parts thereof, as a result of which both eyes in each case perceive substantially different viewpoints A(k) and thereby a spatial visual impression arises, as is shown in FIG. 4 and FIG. 5. In this case, up to a certain degree both eyes of one and the same viewer 3 even see image section data of the same viewpoint A(k), without the spatial impression being disrupted.

The angle, which spans the horizontal and vertical period length of the two-dimensional periodic pattern as opposite and adjacent sides, corresponds substantially to the inclination angle a (see FIG. 2) of the transparent sections on parallax barrier screen 2 with respect to the vertical. In FIG. 3, the opposite side, for example, could be defined by the lower horizontal dashed line and the adjacent side by the right vertical dashed line.

The best channel separation in the 3-D representation is usually achieved in this way.

As in various other 3-D reproduction methods, the viewpoints A(k) each correspond to different perspectives of a scene or an object.

The drawings in FIG. 1 through FIG. 6 are again used to illustrate further an exemplary arrangement according to the invention, which realizes the method of the invention.

FIG. 1 therefore first shows the schematic structure for realizing the arrangement.

Contained therein are an LCD screen, measuring an image diagonal of about 40″, of the type NEC LCD4010 as an image display device, provided with color subpixels R, G, B as image elements x(i,j) in a grid 1 with a resolution of rows i=1, . . . , 768 and columns j=1, . . . , 1360*3=4080, whereby image section data of different viewpoints A(k) with k=1, . . . , n and n=6 can be made visible on the image elements x(i,j) and a parallax barrier screen 2 placed before grid 1 of image elements x(i,j) at the distance s in viewing direction of a viewer 3.

Of course, there can also be several viewers 3 who obtain a spatial impression based on the arrangement according to the invention.

Furthermore, FIG. 2 shows the excerpt of a parallax barrier screen 2 for use in an arrangement of the invention. This parallax barrier screen 2 contains alternately opaque and transparent sections, whereby the transparent sections according to the invention correspond substantially to straight bordered lines, which in parallel projection of parallax barrier screen 2 onto grid 1 of image elements x(i,j) are inclined by at least 21 degrees with respect to the vertical direction of grid 1 of image elements x(i,j) and further in the horizontal direction of grid 1 of image elements x(i,j) in each case have at least the width of 1.9 image elements x(i,j). Said inclination angle of at least 21 degrees is drawn in here as angle a; because the drawing is not to scale, it appears to be even much greater than 21 degrees (and in practice is in fact often greater than 21 degrees). Said required width of the transparent sections is still apparent in FIG. 3 and FIG. 4.

As is known to the person skilled in the art, of course, the parameters for parallax barrier screen 2 are calculated according to the two equations (1) and (2) known from the aforementioned Kaplan article; exemplary parameters are given below. Input parameters in this case are particularly also the height and width of the image elements x(i,j).

The image elements x(i,j) in each case correspond to individual color subpixels (R, G, or B).

Further, FIG. 3 shows an exemplary image combination of the image section data of six different viewpoints A(k) with k=1, . . . , 6. In the arrangement of the invention, the assignment of the image section data of different viewpoints A(k) on grid 1 of image elements x(i,j) occurs advantageously in a strictly two-dimensional periodic pattern. In the example of FIG. 3, the horizontal period length comprises 8 image elements and the vertical period length 6 image elements x(i,j), as 6 color subpixels R, G, B, as indicated in the drawing by the dashed lines.

In this case, the image section data for each image element x(i,j) stem in each case from the position (i,j) from the corresponding viewpoint A(k).

In the design example presented here, the vertical period length therefore corresponds advantageously to the number n=6 of the shown viewpoints.

FIG. 4 and FIG. 5 show view examples for a first or a second viewer's eye taking the relations in FIGS. 1 through 3 as a basis. In this case, parallax barrier screen 2 is arranged at distance s in the viewing direction before grid 1 of image elements x(i,j), i.e., more precisely before the image area of LCD screen 1.

Based on the view limitation effect of parallax barrier screen 2, one or more viewers 3 each see with both eyes substantially different image elements x(i,j) and/or parts thereof, as a result of which both eyes in each case perceive substantially different viewpoints A(k) and thereby a spatial visual impression arises, as is shown in FIG. 4 and FIG. 5. In this case, up to a certain degree both eyes of one and the same viewer 3 even see image section data of the same viewpoint A(k), without the spatial impression being disrupted.

The angle, which spans said horizontal and vertical period length of said two-dimensional periodic pattern as opposite and adjacent sides, corresponds substantially to the inclination angle a (see FIG. 2) of the transparent sections on parallax barrier screen 2 with respect to the vertical. In FIG. 3, the opposite side, for example, would be defined by the lower horizontal dashed line and the adjacent side by the right vertical dashed line.

The best channel separation in the 3-D representation is usually achieved in this way.

As in various other 3-D reproduction methods, the viewpoints A(k) each also correspond to different perspectives of a scene or an object.

To achieve practically easily producible arrangements, parallax barrier screen 2 preferably consists of a glass substrate, to the back of which the actual barrier structure is applied. Other embodiments are possible, such as, for instance, substrates that do not consist of glass (e.g., of plastic).

Preferably, the barrier structure is an exposed and developed photographic film, which is laminated to the back of the glass substrate, whereby preferably the emulsion layer of the photographic film does not face the glass substrate.

Further, parallax barrier screen 2 advantageously contains means to reduce spurious light reflections, preferably at least one interference optical antireflection coating. Typical antiglare matting may also be used.

Parallax barrier screen 2 is applied permanently by means of a spacer element to preserve the further above-defined distance s to image display device 1, for example, glued or screwed on.

For the described exemplary arrangement based on a 40″ LCD screen, the following additional parameters are advantageous:

As is known, the color subpixels (R, G, B) in the example correspond to the image reproducing elements x(i,j), whereby the height is about 0.648 mm and the width about 0.216 mm.

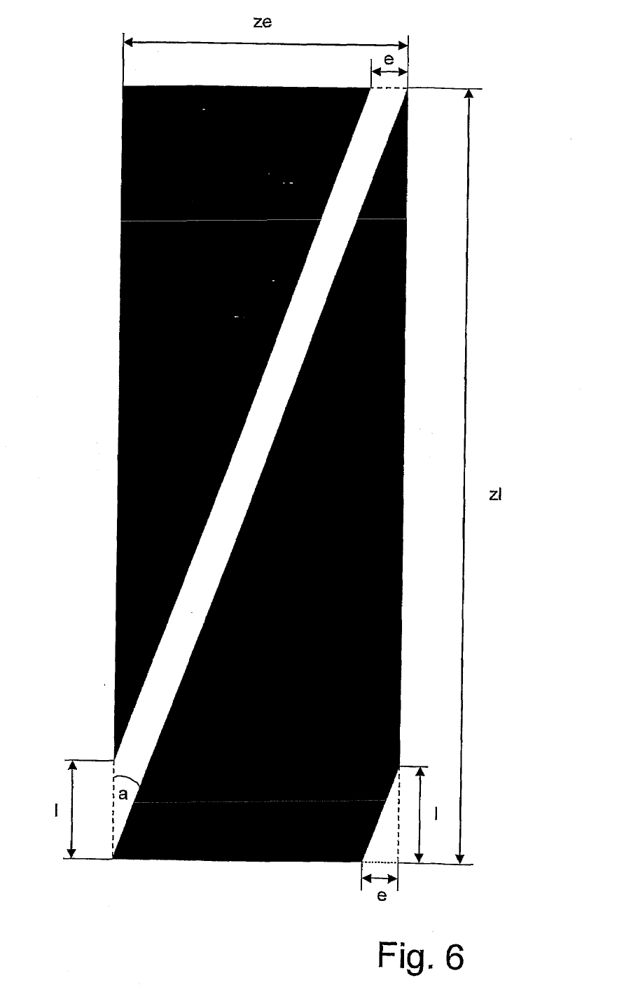

According to the dimensioning in FIG. 6, the transparent sections of parallax barrier screen 2 with respect to the vertical are at an inclination angle a=23.96248897°. The width e of said sections in the horizontal direction of grid 1 with the image elements x(i,j) is 0.4305692 mm and its height l is 0.968781 mm. The horizontal period ze is 1.7222768 mm and the vertical period zl of the transparent sections is 3.875124 mm.

In another embodiment, instead of the 40″ LCD screen, a 32″ LCD screen of the type NEC LCD3210 is used as the image display device.

Here as well, the color subpixels (R, G, B) are used as image reproduction elements x(i,j). In this case, a resolution of rows i=1, . . . , 768 and columns j=1, 1360*3=4080 is also provided, whereby the height of the image reproduction elements x(i,j) is about 0.511 mm and the width about 0.17033 mm, the image section data of the different viewpoints A(k) are arranged according to FIG. 3, the inclination angle a of the transparent sections of parallax barrier screen 2 with respect to the vertical is 23.96248897°, and the width e of said sections in the horizontal direction of grid 1 with the image elements x(i,j) is 0.339776 mm and its height 10.764496 mm.

The horizontal period ze is 1.359104 mm and the vertical period zl of the transparent sections is 3.057984 mm (compare FIG. 6).

It should be noted that the LCD screen NEC LCD3210 and NEC 4010 have in fact natively 1366*3 image elements in the horizontal, but for the pixel-precise control usually only 1360*3=4080 horizontal image elements; i.e., color subpixels R, G, B may be used.

In another exemplary embodiment, a 17″ LCD screen of the type BenQ FP72E is used as the image display device.

Here as well, the color subpixels (R, G, B) are used as image reproduction elements x(i,j). In this case, a resolution of rows i=1, . . . , 1024 and columns j=1, 1280*3=3840 is also provided, whereby the height of the image reproduction elements x(i,j) is about 0.264 mm and the width about 0.088 mm, the image section data of the different viewpoints A(k) are arranged according to FIG. 3, the inclination angle a of the transparent sections of parallax barrier screen 2 with respect to the vertical is 23.96248897°, and the width e of said sections in the horizontal direction of grid 1 with the image elements x(i,j) is 0.175762 mm and its height l 0.3954645 mm.

The horizontal period ze is 0.703048 mm and the vertical period zl of the transparent sections is 1.581858 mm (compare FIG. 6).

The advantages of the invention are multifaceted. In particular, the method of the invention and the corresponding arrangements permit an autostereoscopic representation based on barrier technology, whereby for several simultaneous viewers an improved perceptibility due to improved image brightness, reduced moiré effects, and a visible (monocular) resolution, improved compared with the prior art, are achieved, which was desired. At the same time, a relatively high freedom of movement during 3-D viewing for the viewer(s) can be achieved with the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for spatial representation, the method comprising:
generating visible image section data of different viewpoints A(k) with k=1, . . . , n and n=6 or n=7 on a grid of image elements with rows and columns; and
placing at least one parallax barrier screen that contains alternately opaque and transparent sections before or behind the grid of image elements at a distance, wherein the transparent sections correspond substantially to straight bordered lines, which in parallel projection of the parallax barrier screen onto the grid of the image elements are inclined by at least 21 degrees with respect to the vertical direction of the grid of image elements and further in the horizontal direction of the grid of the image elements and in each case have at least a width of 1.9 image elements,
wherein, one or more viewers based on a view limitation effect by the at least one parallax barrier screen substantially see different image elements and/or parts thereof in each case with both eyes, as a result of which both eyes in each case perceive substantially different viewpoints A(k) such that a spatial visual impression thereby results.

2. The method according to claim 1, wherein the arrangement of the image section data of the different viewpoints A(k) on the grid (1) of image elements x(i,j) occurs in a two-dimensional periodic pattern, whereby the period length in the horizontal and vertical direction does not comprise more than 32 image elements x(i,j) in each case.

3. The method according to claim 2, wherein the vertical period length is equal to the number of the represented viewpoints n.

4. The method according to claim 1, wherein the image elements correspond to color subpixels or clusters of color subpixels or full color pixels.

5. The method according to claim 1, wherein an angle, which spans the horizontal and vertical period length of the two-dimensional periodic pattern as opposite and adjacent sides, corresponds substantially to the inclination angle of the transparent sections on the parallax barrier screen with respect to the vertical.

6. The method according to claim 1, wherein the viewpoints each correspond to different perspectives of a scene or an object.

7. An arrangement for spatial representation, comprising
an image display device having image elements in a grid with rows and columns onto which image section data of different viewpoints A(k) with k=1, . . . , n and n=6 or n=7 are made visible;
at least one parallax barrier screen that is disposed before or behind the grid with image elements at a distance and which contains alternately opaque and transparent sections, the transparent sections corresponding substantially to straight bordered lines, which in a parallel projection of the parallax barrier screen onto the grid with the image elements are inclined by at least 21 degrees with respect to a vertical direction of the grid of image elements and further in a horizontal direction of the grid with the image elements in each case has at least the width of 1.9 image elements,
wherein one or more viewers based on view limitations by the at least one parallax barrier screen substantially see different image elements and/or parts thereof in each case with both eyes, as a result of which both eyes in each case perceive substantially different viewpoints A(k) and a spatial visual impression thereby results.

8. The arrangement according to claim 7, wherein the assignment of the image section data of the different viewpoints A(k) to the image elements occurs in a two-dimensional periodic pattern, whereby the period length in the horizontal and vertical direction does not comprise more than 32 image elements in each case.

9. The arrangement according to claim 8, wherein the vertical period length is equal to the number of the represented viewpoints.

10. The arrangement according to claim 7, wherein the image elements correspond to color subpixels or clusters of color subpixels or full color pixels.

11. The arrangement according to claim 8, wherein an angle, which spans the horizontal and vertical period length of the two-dimensional periodic pattern as opposite and adjacent sides, corresponds substantially to an inclination angle of the transparent sections on the parallax barrier screen with respect to the vertical.

12. The arrangement according to claim 7, wherein the image display device is a color LCD screen, a plasma display, a projection screen, an LED-based display, an SED display, or a VFD display.

13. The arrangement according to claim 8, wherein a number of viewpoints A(k) is equal to 6 image elements and the horizontal period length corresponds to 8 image elements.

14. The arrangement according to claim 7, wherein the parallax barrier screen is made of a glass substrate, to the back of which the barrier structure is applied.

15. The arrangement according to claim 14, wherein the barrier structure is an exposed and developed photographic film, which is laminated to the back of the glass substrate, and wherein the emulsion layer of the photographic film does not face the glass substrate.

16. The arrangement according to claim 14, wherein the opaque areas of the barrier structure are formed by color printed on the glass substrate.

17. The arrangement according to claim 7, wherein the parallax barrier screen contains means to reduce spurious light reflections, preferably at least one interference optical antireflection coating.

18. The arrangement according to claim 7, wherein the parallax barrier screen is applied permanently via a spacer element to the image display device.

19. The arrangement according to claim 7, wherein the image display device is a 17″ LCD screen with color subpixels as image reproduction elements, wherein a height of the image reproduction elements is about 0.264 mm and a width is about 0.088 mm, the image section data of different viewpoints A(k) being arranged as follows

| x(i, j) | 1 | 2 | 3 | 4 | 5 | 6 | 7 | 8 | 9 | . . . |
|---|---|---|---|---|---|---|---|---|---|---|
| 1 | A(1) | A(2) | A(3) | A(3) | A(4) | A(5) | A(6) | A(6) | A(1) | . . . |
| 2 | A(2) | A(3) | A(4) | A(4) | A(5) | A(6) | A(1) | A(1) | A(2) | . . . |
| 3 | A(3) | A(4) | A(5) | A(5) | A(6) | A(1) | A(2) | A(2) | A(3) | . . . |
| 4 | A(4) | A(5) | A(6) | A(6) | A(1) | A(2) | A(3) | A(3) | A(4) | . . . |
| 5 | A(5) | A(6) | A(1) | A(1) | A(2) | A(3) | A(4) | A(4) | A(5) | . . . |
| 6 | A(6) | A(1) | A(2) | A(2) | A(3) | A(4) | A(5) | A(5) | A(6) | . . . |
| 7 | A(1) | A(2) | A(3) | A(3) | A(4) | A(5) | A(6) | A(6) | A(1) | . . . |
| . . . | . . . | . . . | . . . | . . . | . . . | . . . | . . . | . . . | . . . | . . . , |

wherein the transparent sections of the parallax barrier screen have an inclination angle a=23.96248897° with respect to the vertical, the width of the sections in the horizontal direction of the grid with the image elements is 0.175762 mm in each case and the height is 0.3954645 mm, and the horizontal period is 0.703048 mm and the vertical period is 1.581858 mm of the transparent sections.

20. The arrangement according to claim 7, wherein the image display device is a 32″ LCD screen with color subpixels as image reproduction elements, wherein the height of the image reproduction elements is about 0.511 mm and the width is about 0.17033 mm, the image section data of different viewpoints A(k) being arranged as follows

| x(i, j) | 1 | 2 | 3 | 4 | 5 | 6 | 7 | 8 | 9 | . . . |
|---|---|---|---|---|---|---|---|---|---|---|
| 1 | A(1) | A(2) | A(3) | A(3) | A(4) | A(5) | A(6) | A(6) | A(1) | . . . |
| 2 | A(2) | A(3) | A(4) | A(4) | A(5) | A(6) | A(1) | A(1) | A(2) | . . . |
| 3 | A(3) | A(4) | A(5) | A(5) | A(6) | A(1) | A(2) | A(2) | A(3) | . . . |
| 4 | A(4) | A(5) | A(6) | A(6) | A(1) | A(2) | A(3) | A(3) | A(4) | . . . |
| 5 | A(5) | A(6) | A(1) | A(1) | A(2) | A(3) | A(4) | A(4) | A(5) | . . . |
| 6 | A(6) | A(1) | A(2) | A(2) | A(3) | A(4) | A(5) | A(5) | A(6) | . . . |
| 7 | A(1) | A(2) | A(3) | A(3) | A(4) | A(5) | A(6) | A(6) | A(1) | . . . |
| . . . | . . . | . . . | . . . | . . . | . . . | . . . | . . . | . . . | . . . | . . . , |

whereby the transparent sections of the parallax barrier screen have an inclination angle of 23.96248897° with respect to the vertical, the width of the sections in the horizontal direction of the grid with the image elements is 0.339776 mm in each case and its height is 0.764496 mm, and the horizontal period is 1.359104 mm and the vertical period is 3.057984 mm of the transparent sections.

21. The arrangement according to claim 7, wherein the image display device is a 40″ LCD screen with color subpixels an image reproduction elements, wherein the height of the image reproduction elements is about 0.648 mm and the width is about 0.216 mm, the image section data of different viewpoints being arranged as follows:

| x(i, j) | 1 | 2 | 3 | 4 | 5 | 6 | 7 | 8 | 9 | . . . |
|---|---|---|---|---|---|---|---|---|---|---|
| 1 | A(1) | A(2) | A(3) | A(3) | A(4) | A(5) | A(6) | A(6) | A(1) | . . . |
| 2 | A(2) | A(3) | A(4) | A(4) | A(5) | A(6) | A(1) | A(1) | A(2) | . . . |
| 3 | A(3) | A(4) | A(5) | A(5) | A(6) | A(1) | A(2) | A(2) | A(3) | . . . |
| 4 | A(4) | A(5) | A(6) | A(6) | A(1) | A(2) | A(3) | A(3) | A(4) | . . . |
| 5 | A(5) | A(6) | A(1) | A(1) | A(2) | A(3) | A(4) | A(4) | A(5) | . . . |
| 6 | A(6) | A(1) | A(2) | A(2) | A(3) | A(4) | A(5) | A(5) | A(6) | . . . |
| 7 | A(1) | A(2) | A(3) | A(3) | A(4) | A(5) | A(6) | A(6) | A(1) | . . . |
| . . . | . . . | . . . | . . . | . . . | . . . | . . . | . . . | . . . | . . . | . . . , |

wherein the transparent sections of the parallax barrier screen have an inclination angle of 23.96248897° with respect to the vertical, the width of the sections in the horizontal direction of the grid with the image elements is 0.4305692 mm in each case and its height is 0.968781 mm, and the horizontal period is 1.7222768 mm and the vertical period is 3.875124 mm of the transparent sections.
